(19) United States
(12) Patent Application Publication
(10) Pub. No.: US 2024/0109228 A1
(43) Pub. Date: Apr. 4, 2024

(54) METHOD AND APPARATUS FOR PREPARING EXTRUDER READY POLYETHYLENE TEREPHTHALATE

(71) Applicant: NETZERO ENTERPRISES INC., Kelowna (CA)

(72) Inventor: Ronald Ryde, Penticton (CA)

(21) Appl. No.: 18/480,837

(22) Filed: Oct. 4, 2023

Related U.S. Application Data
(60) Provisional application No. 63/413,177, filed on Oct. 4, 2022.

(51) Int. Cl. B29B 17/04; B29B 13/02; B29B 13/06; B29C 48/00

(52) U.S. Cl. CPC B29B 17/0412; B29B 13/02; B29B 13/06; B29C 48/022; B29B 2017/001

(57) ABSTRACT

A system and method for preparing recyclable plastic for extrusion wherein the system comprises a vessel operable to receive a quantity of a raw plastic containing a liquid at or above 212 degrees Fahrenheit to re-crystalize the plastic, a chipper to chip the re-crystalized plastic after removal from the vessel after a predetermined period of time and a dryer to remove the liquid from the chipped re-crystalized plastic. The method comprises heating a quantity of source plastic to a temperature above the re-crystalizing temperature of the source plastic for form a re-crystalized plastic and chipping the re-crystalized plastic

### BACKGROUND

### 1. Technical Field

The present invention relates generally to recycling plastic and more particularly to a system and method for preparing rPET plastic for extrusion.

### 2. Description of Related Art

Due to various environmental concerns, there is a growing need to enable rPET (recycled polyethylene terephthalate) plastics to be recycled. One current area that shows growing promise for recycled plastics is in concrete building material. However, such building materials are commonly formed using elongate lengths of rods of rebar and the like. A common method of forming such reinforcing materials is by combining with a fibrous or other material.

A difficulty with current methods of extruding plastics is that the plastics desired to be recycled include polyethylene terephthalate (PET) which is commonly used to make containers such as plastic bottles, juice containers, food grade clamshells and the like. The difficulty in recycling such PET is that its melting temperature is much higher than most other plastics and it does not blend with any other plastics. PET must therefore be process separately.

Another difficulty with using plastics such as PET for building construction is that most PET plastics are known to be hydroscopic and therefore prone to absorbing moisture. The presence of such moisture is also known to adversely affect the extrusion process for such materials.

### SUMMARY OF THE DISCLOSURE

According to a first embodiment, there is disclosed a system for preparing recyclable plastic for extrusion comprising a vessel operable to receive a quantity of a raw plastic containing a liquid at or above 212 degrees Fahrenheit to re-crystalize the plastic, a chipper to chip the re-crystalized plastic after removal from the vessel after a predetermined period of time and a dryer to remove the liquid from the chipped re-crystalized plastic.

The system may further include a removal device for removing the plastic from the tank after a predetermined time selected to re-crystalize the plastic. The removal device may comprises a conveyor. The removal device may comprise an auger.

The liquid may comprise water. The dryer may comprise a centrifuge. The dryer may comprise a desiccant dryer.

According to a further embodiment, there is disclosed a method for preparing plastic for extrusion comprising heating a quantity of source plastic to a temperature above the re-crystalizing temperature of the source plastic for form a re-crystalized plastic and chipping the re-crystalized plastic

The source plastic may be heated in a liquid bath containing a quantity of a liquid above the re-crystallization temperature of the plastic. The liquid may comprise water. The method may further comprise removing the re-crystalized plastic from the liquid bath by a removal device. The method may further comprise drying the chipped plastic.

The method may further comprise pre-selecting the raw plastic to be introduced to the vessel to be of a predetermined type. The predetermined type may be polyethylene terephthalate. The re-crystallization temperature may be 212 degrees Fahrenheit.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The accompanying drawings constitute part of the disclosure. Each drawing illustrates exemplary aspects wherein similar characters of reference denote corresponding parts in each view,

FIG. 1 is a plan view of a system for preparing recyclable plastic for extrusion.

FIG. 2 is an illustration of the flow chart representing the system of FIG. 1.

### DETAILED DESCRIPTION

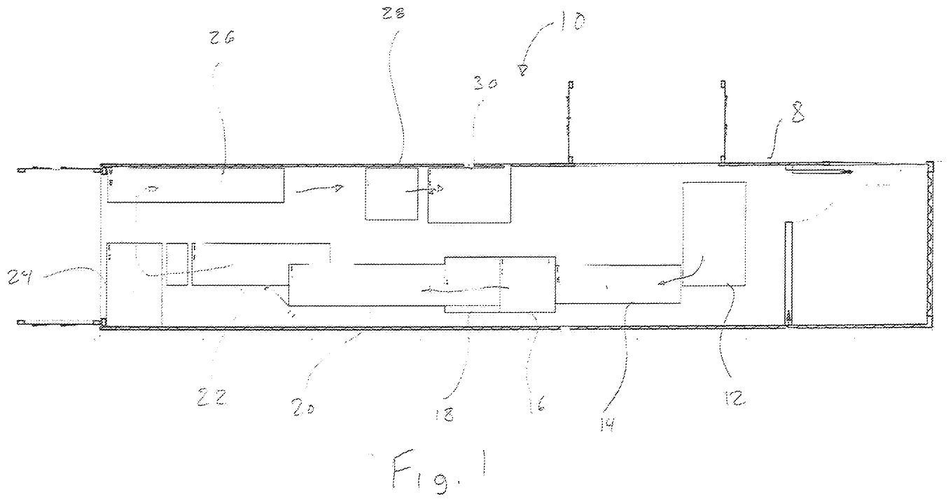

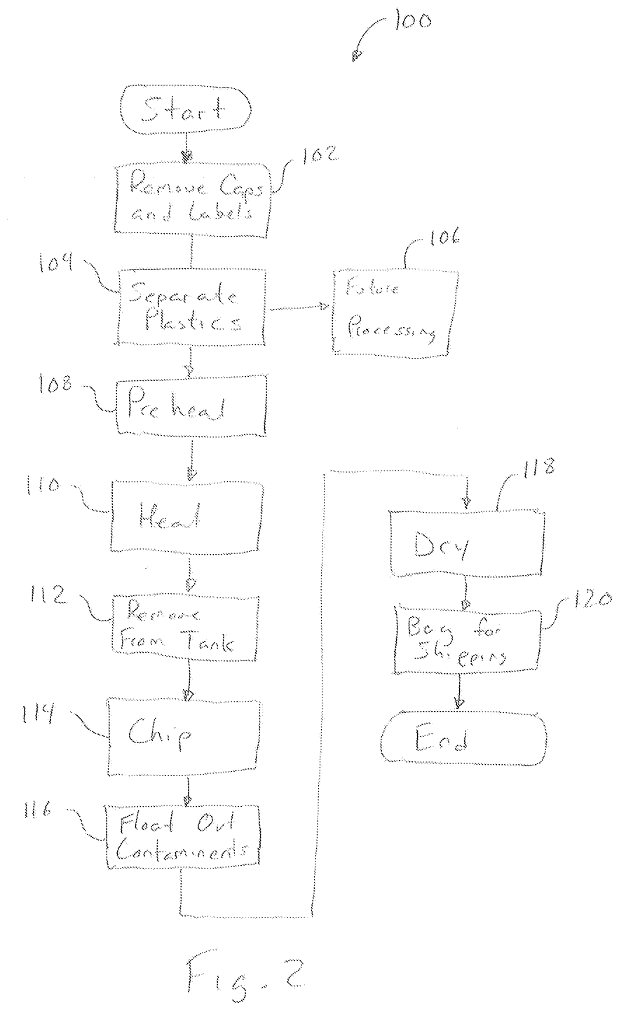

Aspects of the present disclosure are now described with reference to exemplary apparatuses, methods and systems. Referring to FIG. 1, a system 10 for preparing plastic for extrusion is illustrated generally at 10. As illustrated, the system 10 may be located within a vessel, such as by way of non-limiting example, a shipping container 8 or may be arranged at a recycling site in any other desired layout. The system 10 comprises a hot heated water bath 18 to crystalize the plastic, a chipper 24 to dry the crystalized plastic and a dryer to dry the chipped plastic. A flow chart for the process utilizing the system 10 is illustrated in FIG. 2 generally at 100.

As illustrated in FIG. 1, the system may include an optional sorting table 12 operable to receive the plastic to be recycled in steps 102 and 104. The sorting table 12 permits a worker (not shown) to inspect the received plastic to first optionally remove caps and labels in step 102 and sort according to the for the correct or desired plastic types in step 104. In the case of PET, this may comprise sorting the plastic to only be PET. During sorting, the plastic source material may be sorted and separated by colour and product type as well as plastic material type. In particular, it is known that blue tinted or any other coloured plastic may need to be sorted and processed separately. Hard food grade PET or PETE plastic is of a slightly different crystallinity from water bottles. Even though the procedure is the same these products may need to be processed separately in future repetition of the process in step 106. In use, the equipment may be cleaned and re-run to process each different type of plastic that is separated from each other. Although the present method is described for use with recycling #1 PET, it may also be applied to the sorting and processing for recycling of other plastic types as well. The sorting table 12 may optionally include a saw or other means for cutting off or removing unwanted plastic types form the plastic bottles or other articles as the case may be.

The plastic articles are then moved to an infeed roll or conveyor 14. The infeed conveyor 14 may include an optional pre-heating means, such as, by way of non-limiting example, an infrared lamp (not shown) or other heating means in step 108. The infeed conveyor 14 may optionally pass the plastic articles through a crusher 16 (not shown in FIG. 2) operable to crush or otherwise compress the plastic articles. It will be appreciated that the use of the crusher 16 will be advantageous for use in recycling plastic bottles to remove excess air from the bottles and permit them to be submerged in the heated bath as will be set out below. The crusher 16 may comprise any known crushing means, including rollers, belts or movable plates to crush or compress the plastic articles.

The infeed conveyor 14 then deposits the plastic articles into a heated water bath 18 in step 110. The heated bath 18 includes a quantity of water heated to a temperature above a level required to cause the plastic to undergo a state change from amorphous to crystalized. It will be appreciated that this temperature will vary by the type of plastic to be processed. In the case of PET, the desired temperature will be above 212 degrees Fahrenheit (100 degrees Celsius) although it will be appreciated that other temperatures may be utilized for other plastics. Additives may be introduced into the water in the heated bath 18 to increase the boiling temperature. Example of such additives may include acidic chemicals, including vinegary or the like. The heated bath 18 serves to facilitates the removal of labels from bottles or dissolving any other impurities which may be on the plastic articles. The water may be heated in the water bath 18 by any known means, including gas fired burners, electric elements, geothermal, solar or any other known heating means. It will be appreciated that appropriate controls will be provided to maintain the water at the desired temperature as are known.

An article remover 20 is included at a distal end of the heated bath 18. The article remover 20 is adapted to remove the plastic articles from the heated bath 18 in step 112 at a predetermined time has passed while the articles are in the heated bath. The time will be selected to permit the above desired state change in the plastic. It will be appreciated that extra time may be provided to ensure all of the plastic is changed in state to account for thicker plastic or areas of the plastic that are harder to reach by the heated water. The article remover 20 may comprise any known means for removing articles from a liquid bath including, without limitation, augers, belts, scoops or conveyors.

An inspection table 22 may optionally be included at the exit from the article remover 20 to permit a worker (not shown) or computer scanner to inspect the crystalized plastic. In particular, the worker or computer scanner may observe the plastic to ensure that all of it has undergone the desired state change from amorphous to crystalized and that there is no other undesired plastic in the materials removed from the heated water. Sorting and contaminant removal means, including bins, drop down openings and the like may be utilized to remove such undesired substances.

After removal from the heated water and an optional inspection, the crystalized plastic is fed into a chipper 24 which is operable to reduce the size of the crystalized plastic to the desired size in step 114. It will be appreciated that the resulting chip size will be selected to correspond to the intended use of the plastic chips. It will also be appreciated that chipping the crystalized plastic will permit better drying, storage and transportation of the material due to an increased density of the chips over their original shapes.

The chipped plastic may then be passed through another optional float tank 26 for floatation in water or similar liquids. It will be appreciated that crystalized PET is heavier than many other plastic types and therefore the desired plastic will therefore sink to the bottom allowing other materials to float to the top for removal in step 116. This step will further clean and sort the crystalized and chipped plastic. It will be appreciated that although water is utilized for PET, other liquids may also be utilized for other plastics. Other cleaning and sorting means may also be utilized to ensure the resulting plastic chips are clean and uniform.

The chipped plastic may then be dried in one or more steps to remove moisture in step 118. The removal of moisture from the chipped plastic reduces the weight for transportation and shipping and also ensures that the plastic is ready for extrusion without adversely affecting the extrusion process. In particular, the drier may include a first state centrifuge 28 operable to spin the chips thereby removing excess water therefrom. A further optional desiccant 30 may remove further moisture from the chipped plastic including any water absorbed into the plastic material itself. After drying the resulting extrusion ready plastic may be stored and transported in any desired means or may optionally be utilized immediately in an extruder as are known including according to some embodiments, stored in bags in step 120 for shipping or storage.

While specific embodiments have been described and illustrated, such embodiments should be considered illustrative only and not as limiting the disclosure as construed in accordance with the accompanying claims.

What is claimed is:

1. A system for preparing recyclable plastic for extrusion comprising:
a vessel operable to receive a quantity of a raw plastic containing a liquid at or above 212 degrees Fahrenheit to re-crystalize the plastic,
a chipper to chip the re-crystalized plastic after removal from the vessel after a predetermined period of time; and
a dryer to remove the liquid from the chipped re-crystalized plastic.

2. The system of claim 1 further including removal device for removing the plastic from the tank after a predetermined time selected to re-crystalize the plastic.

3. The system of claim 2 wherein the removal device comprises a conveyor.

4. The system of claim 2 wherein the removal device comprises an auger.

5. The system of claim 1 wherein the liquid comprises water.

6. The system of claim 1 wherein the dryer may comprise a centrifuge.

7. The system of claim 1 wherein the dryer comprises a desiccant dryer.

8. A method for preparing plastic for extrusion comprising:
heating a quantity of source plastic to a temperature above the re-crystalizing temperature of the source plastic for form a re-crystalized plastic; and
chipping the re-crystalized plastic

9. The method of claim 8 wherein the source plastic is heated in a liquid bath containing a quantity of a liquid above the re-crystallization temperature of the plastic.

10. The method of claim 9 wherein the liquid comprise water.

11. The method of claim 9 further comprising removing the re-crystalized plastic from the liquid bath by a removal device.

12. The method of claim 9 further comprising drying the chipped plastic.

13. The method of claim 1 further comprising pre-selecting the raw plastic to be introduced to the vessel to be of a predetermined type.

14. The method of claim 13 wherein the predetermined type is polyethylene terephthalate.

15. The method of claim 14 wherein the re-crystallization temperature is 212 degrees Fahrenheit.
